(19) United States
(12) Patent Application Publication
(10) Pub. No.: US 2015/0292659 A1
(43) Pub. Date: Oct. 15, 2015

(54) PIPE FITTING

(71) Applicant: Freeflow, LLC, Bluffdale, UT (US)

(72) Inventors: Robert Mathews, Bluffdale, UT (US); Howard Mecham, Murray, UT (US); Kenneth Sykes, Bluffdale, UT (US)

(73) Assignee: Freeflow, LLC, Bluffdale, UT (US)

(21) Appl. No.: 14/253,052

(22) Filed: Apr. 15, 2014

(51) Int. Cl. F16L 29/00; F16K 3/30

(52) U.S. Cl. CPC F16L 29/007; F16K 3/30

(57) ABSTRACT

A pipe fitting comprises a number of orifices defined in a number of connecting ends, a gate housing dividing the pipe fitting into a first section and a second section; and a gate disposed within the gate housing to selectively seal the first section from the second section, in which the gate comprises a manufactured breakaway. A pipe fitting comprises a number of orifices defined in a number of connecting ends, a gate housing dividing the pipe fitting into a first section and a second section, and a gate within the gate housing to selectively seal the first section from the second section, in which the gate comprises a manufactured breakaway, and in which at least portions of the pipe fitting are constructed of a transparent material.

### BACKGROUND

The present application relates to pipe fittings used in the construction of new buildings or the renovation of the plumbing and water systems of existing buildings. Pipe fittings provide the ability to link two straight pipe sections together. In some circumstances, it is necessary to perform testing and inspections on plumbing systems at these fittings and throughout the pipe system to ensure that the pipe system is properly installed and meets the requirements of local building code. Existing pipe fittings are cumbersome during the performance of building inspections, requiring the use of a significant amount of time, equipment, and specialized training.

### BRIEF DESCRIPTION OF THE DRAWINGS

The accompanying drawings illustrate various examples of the principles described herein and are a part of the specification. The examples do not limit the scope of the claims.

FIG. 1 is a perspective, exploded view of a pipe fitting, according to one example of principles described herein.

FIG. 2 is a side view of the pipe fitting of FIG. 1 with the gate in an opened position, according to one example of principles described herein.

FIG. 3 is a side view of the pipe fitting of FIG. 1 with the gate in a closed position, according to one example of principles described herein.

FIG. 4 is a side view of the pipe fitting of FIG. 1 with the gate in the opened and bent position, according to one example of principles described herein.

FIG. 5 is a front cut-away view of the pipe fitting of FIG. 1 along line “A” of FIG. 2, according to one example of principles described herein.

Throughout the drawings, identical reference numbers designate similar, but not necessarily identical, elements.

### DETAILED DESCRIPTION

As briefly described above, pipe fittings provide the ability to link two pipe sections together. These pipes may connect complex systems that are inspected individually before being joined. The drain line between a building and an existing pipe supplied by a developer are one example of this. The existing style of fitting used between a new building's drain line and the existing line requires a method of inspection that can be cumbersome, time consuming, and requires specific equipment to perform. This equipment, for example, includes a gasket test tee, a test ball, a push in cap, and a device to pump air into the test ball.

The present pipe fitting eliminates the need for the testing equipment described above. This pipe fitting, therefore, simplifies the pipe system inspection process, and greatly decreases costs to contractors, sub-contractors, property owners, and others involved in the building and purchasing of the building in which the present pipe fitting is installed. In one example, the pipe fitting is made of a clear material. This allows for a building inspector to determine that fluids such as water is flowing and present in the system, without needing to use the gasket test tee, test ball, push in cap, and device to pump air into the test ball described above. The pipe fitting comprises a gate located near the center of the fitting. The gate, when closed, prevents fluids from flowing and allows the system on either the upstream side or downstream side of the pipe system with respect to the pipe fitting to pressurize and ensure that there are no leaks. When the gate is opened, fluid is allowed to flow freely through the pipe system. In one example, the gate may be locked in the open position and/or the closed position. This locking may enable the user of the pipe fitting to perform an inspection processes any number of times.

In one example, the gate may be bent or folded from a vertical position to a horizontal position with respect to a portion of the gate. The bend may occur at a manufactured breakaway (112) engineered in the gate. In one example, the manufactured breakaway (112) may be a living hinge. As living hinge is a thin flexible hinge or flexure bearing. In this example, the living hinge may be made from the same material as the two pieces it connects. A living hinge may be manufactured by thinning or cutting material to allow the two pieces to bend with respect to one another along the line of the living hinge. A living hinge imparts minimal friction and very little wear in the overall system. Further, the living hinge may be manufactured at a relatively lower cost than other forms of hinges and with relatively easier manufacturing processes.

In one example, the manufactured breakaway (112) may be engineered to permanently bend the gate with respect to the pipe fitting. In this example, the manufactured breakaway (112) is comprised of a material or formed with the ability to elastically bend and deform without breaking the connection between the two sections of the gate. In another example, the manufactured breakaway may be engineered to non-permanently bend the gate with respect to the pipe fitting. In one example, once bent at the manufactured breakaway, the gate may to be left indefinitely. In that position, the pipe system including the pipe fitting may be back filled to cover the pipe system. The dirt filled over the pipe fitting fills over the bent gate, and secures the gate in that position.

The present application, therefore, describes a pipe fitting comprising a number of orifices defined in a number of connecting ends, and a gate housing dividing the pipe fitting into two sections. Further, a gate is included within the gate housing to selectively seal approximately one half of the pipe fitting from the other.

The present application further describes a pipe fitting comprising a number of orifices defined in a number of connecting ends, and a gate housing dividing the pipe fitting into two sections. The present application further describes a pipe fitting comprising a gate housing dividing the pipe fitting into two sections, and a gate within the gate housing to selectively seal one side from another.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language indicates that a particular feature, structure, or characteristic described in connection with that example is included as described, but may not be included in other examples.

In the present specification and in the appended claims, the term “pipe fitting” is meant to be understood broadly as a device used in a pipe system to connect pipe or tubing sections. In one example, pipe fittings may adapt to different sizes or shapes of pipes, and may regulate or measure fluid flow. Although the present application describes a pipe fitting that is used to interface between the drain line of an existing sewer system and a commercial or residential building, there may be other examples in which the present pipe fitting may be applied and used.

Additionally, as used in the present specification and in the appended claims, the term “a number of” or similar language is meant to be understood broadly as any positive number comprising 1 to infinity; zero not being a number, but the absence of a number.

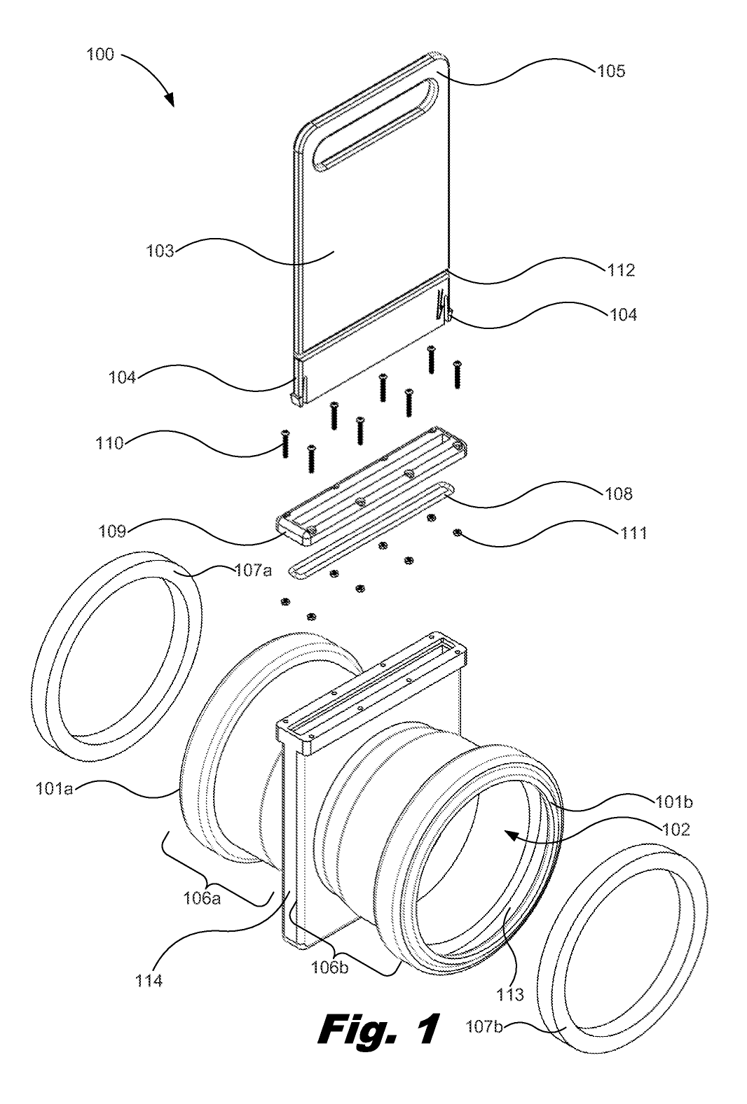

Turning now to the figures, FIG. 1 shows a front perspective, exploded view of a pipe fitting (100), according to one example of principles described herein. The pipe fitting (100) may be made of any material including, for example, clay, metals and metal alloys such as brass, copper, and cast iron, polyvinyl chloride (PVC), chlorinated polyvinyl chloride (CPVC), unplasticized polyvinyl chloride (UPVC), polypropylene (PP), polyethylene (PE), low density polyethylene (LDPE), high density polyethylene (HDPE), polyvinylidene fluoride (PVDF), or acrylonitrile butadiene styrene (ABS), among other types of materials.

In another example, the pipe fitting (100) may be made of a transparent material to allow for the inspection of the flow of fluids through the pipe fitting (100) as will be described in more detail below. In this example, that transparent material allows the interior cavity of the pipe fitting (100) to be visually inspected from the exterior of the pipe without the use of specific tools. With the gate (103) in the closed position, it is possible to inspect the upstream or downstream systems connected to the pipe fitting (100) for leaks, visually confirming that fluid such as water has reached the pipe fitting and is not leaking from any joints in the pipe systems. In another example, the pipe fitting (100) may be made of an opaque material.

The material used to construct the pipe fitting (100) may be a material sufficiently strong to withstand an interior pressure necessary for a pressurized plumbing system. In one example this may be at least 5 pounds per square inch (psi), which is a standard pressure used in inspection of blackwater and greywater sewage systems as to several local ordinances. In another example, the maximum pressure may be more or less. In still another example, the material used to construct the pipe fitting (100) may be a schedule 5, 10, 20, 30, 40, 60, 80, 100, 120, 140, or 160 pipe fitting.

In yet another example, the length of pipe (101) may be constructed of a non-transparent material, with a clear viewing section or window built into a portion of the pipe fitting (100) to allow for external visual inspection of the interior of the pipe fitting (100).

A pipe fitting (100) may comprise a number of connecting ends (101a, 101b) referred herein collectively as 101. The connection ends (101) comprise pipe orifices (102) defined therein to receive lengths of pipe to which the pipe fitting (100) is coupled, and that couple a number of lengths of pipe. One pipe orifice (102) is depicted in FIG. 1, However, each connection end (101) comprises a pipe orifice (102) defined therein.

A gate housing (114) may be located between the connecting ends (101) of the pipe fitting (100). The gate housing (114) houses a gate (103) to seal a first section (106a) of the pipe fitting (100) from a second section (106b), and to prevent fluid from flowing through the pipe fitting (100). The gate housing (114) may comprise a gate housing top (109), a number of gate gaskets (108), a number of gate housing screws (110), and a number of gate housing nuts (111). The gate housing (114) will be described in further detail below.

The gate (103) comprises a gate handle (105), a number of gate latches (104), and a manufactured breakaway (112), each of which will be described in more detail below. The pipe fitting (100) may further comprise a number of pipe sections (106a, 106b) referred herein collectively as 106. The pipe sections (106) may be of equal or unequal length. Each pipe section (106) comprises a pipe orifice (102) defined therein.

The pipe sections (106), as described above, comprise a pipe orifice (102) defined therein, and located to either side of the gate housing (114). In one example, the pipe sections (106) may comprise the connecting ends (101a, 101b). The connecting ends (101) may selectively couple to an external length of pipe or an overall pipe system. The connecting ends (101) may be permanently attached to the external length of pipe. In one example, the pipe fitting (100) may be a compression fitting. In a compression fitting, the connecting ends (101) are joined to lengths of pipe via a number of gaskets (107a, 107b) referred herein collectively as 107. The connecting ends (101) may comprise a number of gasket recesses (113) defined within the pipe sections (106). The gasket recess (113) house a number of pipe gaskets (107). In one example, the pipe gaskets (107) may be used to further ensure a hermetic seal between the connecting end (101) and a length of pipe.

In another example, the permanent connection may be provided through the application of a chemical bonding agent such as, for example, solvent cements. In another example, the permanent connection may be provided through a heat-fusion process such as butt-fusion process. In these examples, the connecting ends (101) may be formed in a different manner to provide a portion of the connecting ends (101) to abut the lengths of pipe directly.

The pipe fitting (100) discussed herein may be formed to couple with any diameter, length, or size of pipe. Thus, the connecting ends (101a, 101b) may be of any diameter to couple with any diameter, length, or size of pipe. Some examples of the diameters of the connecting ends (101a, 101b) may be ½, ¾, 1, 1¼, 1½, 2, 2½, 3, 4, 5, 6, 8, 10, 12, 14, and 16 inch diameters. In one example, the diameter of the first connecting end (101a) may be different from the diameter of the second connecting end (101b). In another example, the material thickness of the connecting ends (101) may be any thickness necessary to perform the function of containing a reasonable pressure distributed evenly throughout the inside of the pipe system.

The gate housing (114) as described above, may comprise a gate housing top (109), a number of gate gaskets (109), a number of gate housing screws (110), and a number of gate housing nuts (111). In one example, the gate housing top (109) may secure over the gate (103) to secure the gate (103) within the gate housing (114). In one example, a number of gate housing screws (110) and a number of gate nuts (111) may be used to secure the gate housing top (109) to the gate housing (114). In one example, a number of gate gaskets (108) may be located between the gate (103) and the gate housing (114) to hermetically seal the junction between the gate (103) and the gate housing (114). In another example, the gate screws (110) may be replaced with a chemical bonding agent or glue that may secure the gate housing top (109) to the gate housing (114). In still another example, the gate housing top (109) and the gate housing (114) may be coupled using a number of latches, clamps, rivits, screws, or other forms of fasteners.

The gate (103), as described above, comprises a gate handle (105), a number of gate latches (104), and a manufactured breakaway (112). In one example, the gate handle (105) may be located near the top of the gate, in a location that allows a user may pull upwards or push downwards on the gate handle (105) to move the entire gate (103) vertically within the gate housing (114). The gate handle (105) is capable of supporting sufficient force such that the force the gate latches (104) provide in securing the gate (103) in an open or closed position within the gate housing (114) is overcome. In one example, the gate latches (104) may be spring clips that provide a spring bias in the direction of engagement with the gate housing (114) as will be described in more detail below. In one example, the gate latches (104) may be located near the bottom of the gate (103) on either side of the gate (103). In one example, the gate latches (104) are biased in an outward direction with respect to the gate (103) to create a force on the inner walls of the gate housing (114). In this manner, the gate latches (104) secure the gate (103) in a number of positions such as, for example, an open position, a closed position, or a position intermediary to opened and closed.

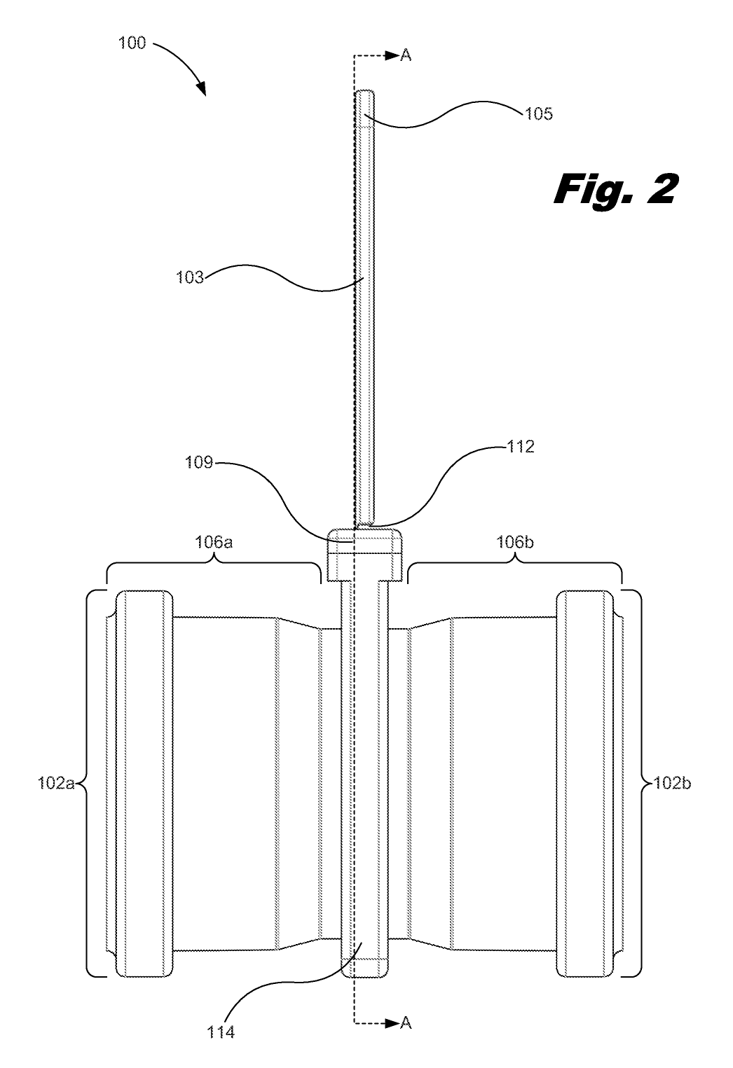

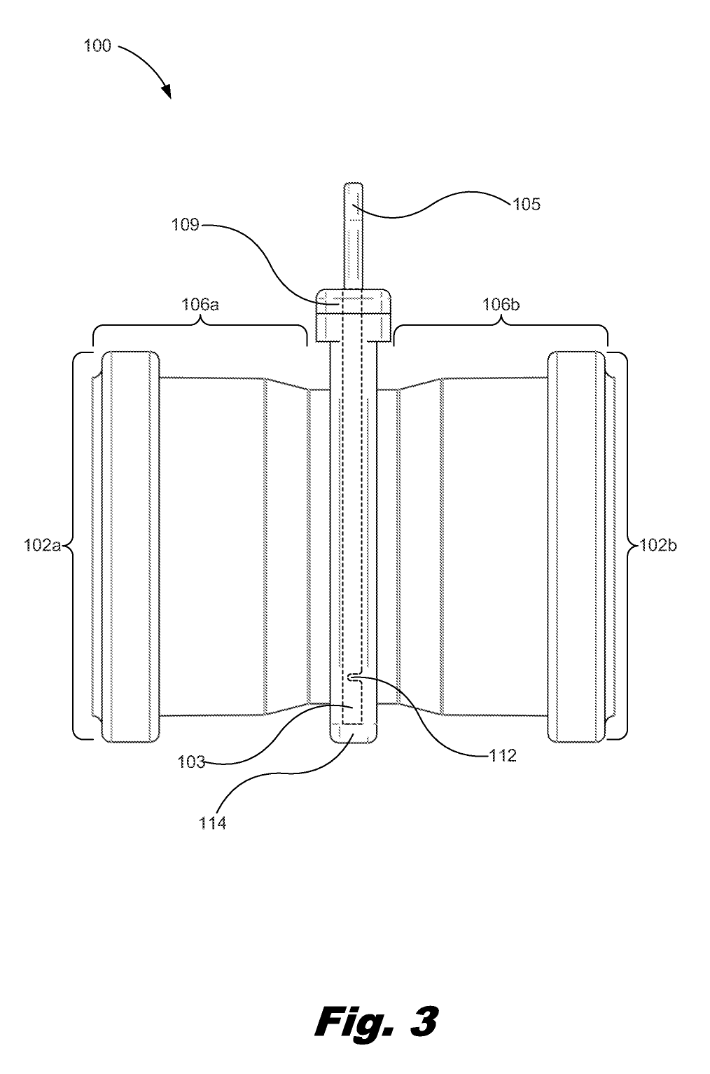

FIG. 2 is a side view of the pipe fitting (100) of FIG. 1 with the gate in an opened position, according to one example of principles described herein. An open position refers herein to the gate (103) being clear of the pipe orifice (102) and not obstructing the flow of fluids from the first section (106a) of the pipe fitting (100) to the second section (106b). In contrast, FIG. 3 is a side view of the pipe fitting (100) of FIG. 1 with the gate in a closed position, according to one example of principles described herein. A closed position refers herein to the gate being positioned to obstruct the flow of fluids from the first section (106a) of the pipe fitting (100) to the second section (106b), and to ensure the gate (103) forms a hermetic seal between the first section (106a) of the pipe fitting (100) to the second section (106b) with respect to the gate housing (114). As depicted in FIG. 3, the gate (103) is partially depicted in ghost using dashed lines to demonstrate how the gate (103) moves and seats within the gate housing (114). This hermetic seal between the first section (106a) of the pipe fitting (100) to the second section (106b) with respect to the gate housing (114) may be further accomplished through the use of a number of gate gaskets (108) as will be described in more detail below.

An intermediary position refers herein to the gate being positioned between an open position and a closed position. In either the open or the closed positions, the gate latches (104) may secure into a number of recesses defined in the gate housing (114) to lock the gate (103) in the respective positions.

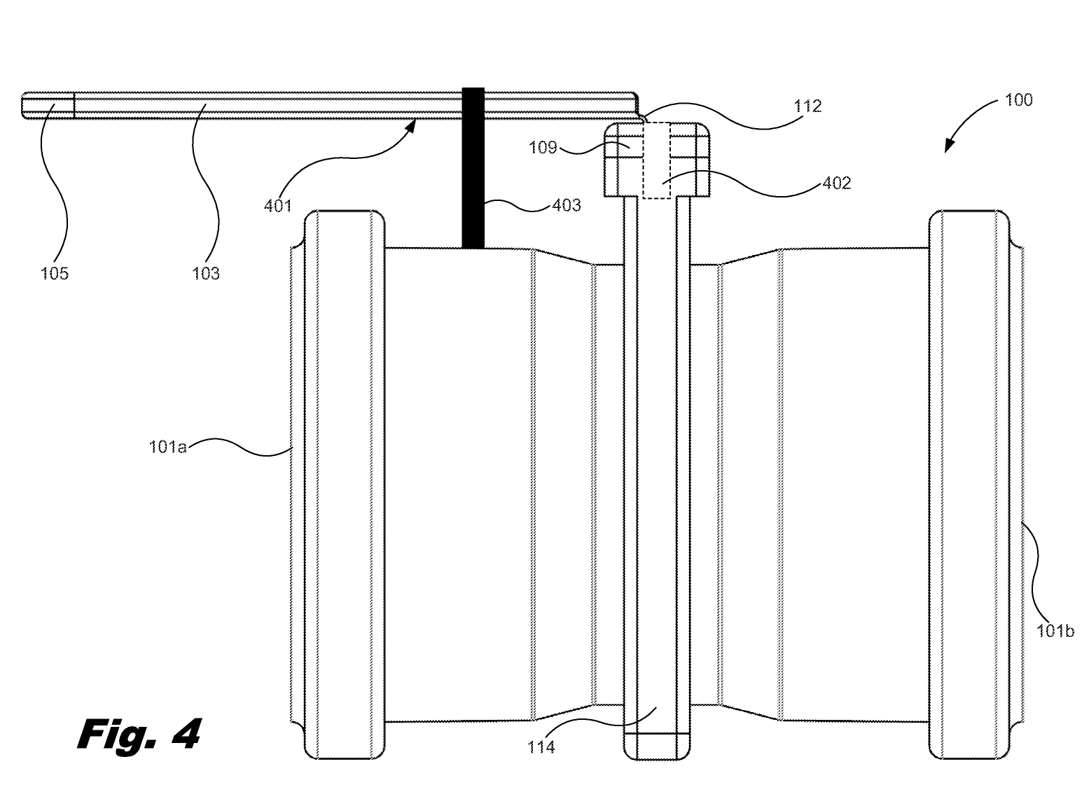

FIG. 4 is a side view of the pipe fitting (100) of FIG. 1 with the gate in the opened and bent position, according to one example of principles described herein. During, for example, inspection of the hermetical soundness of the pipe system in which the pipe fitting (100) is coupled, the user may open and close the gate (103) as depicted in FIGS. 2 and 3 any number of times. This provides the advantage of allowing the user to perform any number of tests on the pipe system to ensure that no leaks in the pipe system exist and to demonstrate to an inspector or other individual that the pipe system is hermetically sealed.

Once testing of the hermetical soundness of the pipe system is complete, the gate (103) of the pipe fitting (100) may be bent over as depicted in FIG. 4. In one example, the bend may occur at a manufactured breakaway (112) engineered in the gate (103). In one example, the manufactured breakaway (112) may be engineered to permanently bend the gate (103) with respect to the pipe fitting (100). In another example, the manufactured breakaway (112) may be engineered to non-permanently bend the gate (103) with respect to the pipe fitting (100). The manufactured breakaway (112) separates the gate (103) to form a first end (401) and a second end (402). The first end (401) comprises the handle (105). The second end (402), depicted in FIG. 4 in ghost using dashed lines, remains housed in the gate housing (114). The retention of the second end (402) in the gate housing (114) ensures that fluids flowing through the pipe fitting (100) do not exit out the top of the gate housing top (109). The gate gasket (108) sealing the gate housing top (109) to the gate housing (114) ensures that fluids do not exit the pipe fitting (100) between the second end (402) and the gate housing (114).

In one example, once bent at the manufactured breakaway (112), the gate (103) may to be left indefinitely. In that position, the pipe system including the pipe fitting (100) may be back filled to cover the pipe system. The dirt filled over the pipe fitting (100) fills over the bent gate (103), and secures the gate (103) in the bent position. In this manner, the second end (402) of the gate (103) cannot be pushed down into the pipe fitting (100) after the gate (103) has been bent. The gate latches also ensure that the second end (402) of the gate (103) is not pushed down into the pipe fitting (100).

In one example, the manufactured breakaway (112) is engineered to allow for the bending of the gate (103) with respect to the pipe fitting (100) such that the first end (401) and second end (402) are not completely or permanently uncoupled from one another. This ensures that the second end (402) of the gate (114), if otherwise uncoupled from the first end (401), does not fall into the gate housing (114), and allow fluids to exit the opening of the gate housing top (109) of the gate housing (114).

In still another example, the manufactured breakaway (112) is engineered to allow for the bending of the gate (103) with respect to the pipe fitting (100) such that the first end (401) and second end (402) may be completely or permanently uncoupled from one another. In this example, the second end (402) of the gate (114) is secured by the gate latches (104) in the open position. In this manner, the second end (402) does not fall into the gate housing (114) and allow fluids to exit the opening of the gate housing top (109) of the gate housing (114).

In another example, the pipe fitting (100) may further comprise a retention latch (403). The retention latch (403) may be secured to a portion of the pipe fitting (100) such as, for example, one of the pipe sections (106a, 106b). The retention latch (403) may selectively secure the gate (103) in the bent position. In this manner, the retention of the gate (103) in the bent position and the second end (402) in the gate housing (114) ensures that the gate (103) does not fall into the gate housing (114) and fluids flowing through the pipe fitting (100) do not exit out the top of the gate housing top (109).

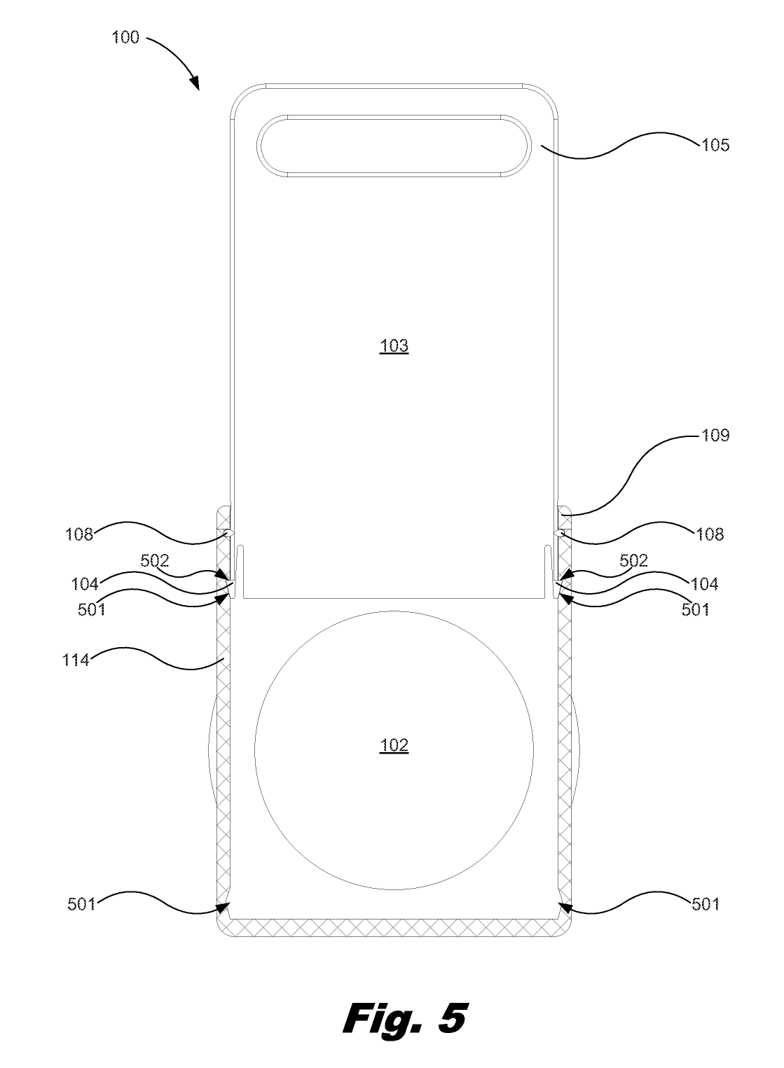

FIG. 5 is a front cut-away view of the pipe fitting (100) of FIG. 1 along line “A” of FIG. 2, according to one example of principles described herein. As depicted in FIG. 5, a number of gate latches (104) secure the gate (103) in an open or closed position within the gate housing (114). The gate latches (104) are biased in an outward direction with respect to the gate (103) to create a force on the inner walls of the gate housing (114). A number of gate latch recesses (501) may be defined within the interior of the gate housing (114). The gate latch recesses (501) assist in securing the gate in an opened or closed position. In one example, any number of gate latch recesses (501) may be defined in the interior of the gate housing (114). In this example, the gate (103) may be secured at any intermediary positions in addition to the opened and closed positions. This may allow for a relatively small amount of fluid to move through the pipe system.

In one example, the gate latch recesses (501) used to secure the gate (103) in an open position may be formed differently with respect to the gate latch recesses (501) used to secure the gate (103) in a closed or intermediate position. The gate latch recesses (501) used to secure the gate (103) in an open position may comprise an upper stopping edge (502). This upper stopping edge (502) ensures that the gate latches (104) cannot be disengaged from the gate latch recesses (501) used to secure the gate (103) in an open position. This also ensures that the gate (103) cannot be removed from the gate housing (114).

As described above, the gate latches (104) secure the gate (103) in a number of positions such as, for example, an open position, a closed position, or a position intermediary to opened and closed. The user may move the gate (103) from these various positions by overcoming the spring bias provided by the gate latches (104).

As discussed above, the pipe fitting (100) may be constructed of a clear or transparent material. In this example, with the gate (103) in an open, closed, or intermediate position, it will be possible to verify through visual inspection that fluid is or is not flowing freely through the pipe fitting (100). In this manner, an inspector, for example, may verify that the pipe system is hermetically sealed and otherwise in compliance with a number of standards and regulations.

The specification and figures describe a pipe fitting that allows the user to link two plumbing systems together and to test the integrity of those systems without additional equipment. The transparent construction of the device allows for a visual inspection, and the gate (FIG. 1, 103) allows the pipe sections (106) to be selectively isolated and hermetically sealed from one another. By pressurizing the system with the gate (103) closed, the user may verify the integrity of the attached system. By opening the gate (103), the user may verify the flow of fluid through the system by visual inspection by looking through the transparent pipe fitting (100). The user may also fold the gate (103) down to minimize its profile. At no point in time will the hermetic seal between the gate (103) and the gate housing (114) be compromised. The connecting ends (101) may also hermetically seal with the existing pipe systems on either side, either through physical or chemical means. This pipe fitting (100) may have a number of advantages, including the ability to test a drain waste vent system without the need for specialized equipment.

The preceding description has been presented to illustrate and describe examples of the principles described. This description is not intended to be exhaustive or to limit these principles to any precise form disclosed. Many modifications and variations are possible in light of the above teaching.

What is claimed is:

1. A pipe fitting comprising:
a number of orifices defined in a number of connecting ends; and
a gate housing dividing the pipe fitting into a first section and a second section; and
a gate disposed within the gate housing to selectively seal the first section from the second section;
in which the gate comprises a manufactured breakaway.

2. The pipe fitting of claim 1, in which the connecting ends further comprise a number of gasket recesses defined in the connecting ends, in which the gasket recesses comprise a number of gaskets for connecting lengths of pipe to the pipe fitting.

3. The pipe fitting of claim 2, in which the gaskets hermetically seal the pipe fitting with respect to the connecting lengths of pipe.

4. The pipe fitting of claim 1, in which connecting ends of the pipe fitting are formed to allow the creation of a connection with a number of lengths of pipe via chemical bonding.

5. The pipe fitting of claim 1, in which the gate further comprises a number of gate latches to lock the gate in an open, closed, or intermediary position.

6. The pipe fitting of claim 5, in which the gate latches of the gate engage with a number of recesses defined in the wall of the pipe fitting.

7. The pipe fitting of claim 6, further comprising a stopping edge defined in a number of recesses used to secure the gate in an open position, the stopping edge preventing the gate from extending beyond a cavity defined by the gate housing in which the gate is contained.

8. The pipe fitting of claim 1, in which the manufactured breakaway comprises a horizontal machined cutout across the gate that allows the gate to be bent from a vertical to a horizontal position.

9. The pipe fitting of claim 8, in which the manufactured breakaway, when bent, locks the gate in an open position.

10. The pipe fitting of claim 8, in which the manufactured breakaway is comprised of a material that elastically deforms without breaking a connection between two sections of the gate divided by the manufactured breakaway.

11. The pipe fitting of claim 1, further comprising a number of gate gaskets to hermetically seal the gate with respect to the pipe fitting.

12. The pipe fitting of claim 11, in which a number of gate gaskets are located between the gate housing and the gate.

13. The pipe fitting of claim 12, in which the gasket between the gate housing and the gate is located at the top of the pipe.

14. The pipe fitting of claim 1, in which the length of pipe is constructed of a transparent material.

15. A pipe fitting comprising:
a number of orifices defined in a number of connecting ends;
a gate housing dividing the pipe fitting into a first section and a second section; and
a gate within the gate housing to selectively seal the first section from the second section;
in which the gate comprises a manufactured breakaway, and
in which at least portions of the pipe fitting are constructed of a transparent material.

16. The pipe fitting of claim 15, in which the gate further comprises a number of gate latches to lock the gate in an open, closed, or intermediary position.

17. The pipe fitting of claim 16, in which the gate latches of the gate engage with a number of recesses defined in the wall of the pipe fitting.

18. The pipe fitting of claim 6, further comprising a stopping edge defined in a number of recesses used to secure the gate in an open position, the stopping edge preventing the gate from extending beyond a cavity defined by the gate housing in which the gate is contained.

19. A pipe fitting comprising:
a gate housing dividing the pipe fitting into a first section and a second section; and
a gate within the gate housing to selectively seal the first section from the second section, and
a manufactured breakaway to secure the gate in an open position with respect.

20. The pipe fitting of claim 20, in which the manufactured breakaway is comprised of a material that elastically deforms without breaking a connection between two sections of the gate divided by the manufactured breakaway.
